(19) United States
(12) Patent Application Publication
(10) Pub. No.: US 2013/0186009 A1
(43) Pub. Date: Jul. 25, 2013

(54) Window Rough Opening Seal and Method of Sealing a Window Rough Opening

(71) Applicant: Ross Hart, Houston, TX (US)

(72) Inventor: Ross Hart, Houston, TX (US)

(21) Appl. No.: 13/740,339

(22) Filed: Jan. 14, 2013

Related U.S. Application Data
(60) Provisional application No. 61/590,608, filed on Jan. 25, 2012.

(51) Int. Cl. E06B 1/62

(52) U.S. Cl. CPC E06B 1/62
USPC 52/58; 52/741.4

(57) ABSTRACT

Disclosed is a window rough opening article of flashing that provides a moisture barrier and a uniform caulking surface upon which to apply sealant material between a window rough opening and an installed window frame positioned therein. The article is a structure formed of a continuous sheet of material, whereby the material forms a uniform return flange, a first nailing flange, and an optional outer flange. The return flange is placed over the thickness of the rough opening, while the nailing flange is secured about the outer perimeter of the rough opening and is fastened thereto. The optional outer flange is adapted for use with stucco façade, and the single flange embodiment is adapted for use with brick façade. The device is cut to length and installed, wherein adjacent segments and corner joints are installed using a lap joint configuration to prevent cold joints along the rough opening interface.

### CROSS REFERENCE TO RELATED APPLICATION

This application claims the benefit of U.S. Provisional Application No. 61/590,608 filed on Jan. 25, 2012, entitled “Window Closure.” The above identified patent application is herein incorporated by reference in its entirety to provide continuity of disclosure.

### BACKGROUND OF THE INVENTION

1. Field of the Invention

The present invention relates to commercial construction and window framing. More specifically, the present invention pertains to an article of flashing that provides a moisture barrier and a clean surface upon which to seal a window being mounted into a rough opening.

When installing a new window in an existing wall or installing a window during commercial building construction, proper framing and sealing of the window in relation to the wall rough opening is imperative for the thermal efficiency of the building. The window rough opening is the defined perimeter opening created in the wall that accepts and secures a finished window assembly therein. Generally this area comprises a horizontal header and sill separated by trimmer studs that define a generally rectangular opening in the wall. The elements of the rough opening are supported by adjacent studs such that the trimmer studs, header, and sill are securely in position prior to mounting the window therein.

A rough opening cross section generally comprises a composition of wall studs, gypsum sheathing material, and additional window framing lumber. This creates a non-uniform substrate upon which to applying sealing or caulking material, which is used between the rough opening and the perimeter of the window assembly to prevent air and moisture penetration. The attachment between lumber about the perimeter of the rough opening and the sheathing material creates a cold joint that does not seal the rough opening against air and moisture infiltration. This reduces the thermal efficiency of the structure and allows moisture to infiltrate and potentially damage this joint over time.

The primary cause of water and air intrusion into the building is an inadequate seal around a window perimeter. Improperly sealed areas between the rough opening perimeter and the installed window frame allow for discontinuous thermal resistance along a building wall, which in turn allows air and moisture penetration that leads to increased heating and cooling costs, and the potential for damage of the rough opening material due to water intrusion. The space between the window frame and rough opening has always been the weak point of all waterproofing and damp proofing designs. There exist two areas of concern. First, lack of a positive seal around the installed window frame allows rain water and air to penetrate directly into the interior. Secondly, and more discrete, is the effect of lower pressure inside the building with respect to the exterior, which pulls water vapor from the cavity wall and into the building.

These problems have been addressed with independent efforts with varied success. To keep rain water out of the rough opening, the typical design is to attach a flexible membrane element from the rough opening directly to the window frame. The primary issue with this application is the material incompatibility of the products used to seal the joint. The membrane is usually an asphalt-based product, while the sealant material utilized to fill the gaps is a silicone-based product; these products are not compatible with each other. The other primary solution is to create a physical “dam” around the rough opening. Typically, this is a piece of wood or gypsum board, which will reduce the effects of the negative pressure when properly flashed. However, flashing the window frame is generally completed after the window frame has already been installed, exposing the window to damage when installing the flashing and when installing the building façade material thereafter.

The present invention pertains to a window rough opening flashing device that provides an improved moisture barrier that prevents water intrusion and further provides a uniform surface upon which to apply sealant material. Moisture is prevented from entering into a rough opening between the window frame and the backup wall, while the cross section of the rough opening is covered such that sealant can be readily applied thereto. The device includes a defined shape that not only creates a moisture dam around the rough opening, but also provides an excellent surface upon which to apply sealant material thereto and between the window frame and the rough opening. When the present invention is installed in the normal construction sequence, it allows the window to be installed after the exterior façade is in place. This schedule prevents damage to the window frame or glass by other tradesman (masonry or stucco contractors) during the construction event. A further benefit is the invention is manufactured in standard lengths and is field cut to fit any openings, conforming to the dimensions of the window rough opening and lapped together in segments without compromising the sealed interface. When horizontal and vertical members of the present invention interface, they overlap to prevent cold joints, while sections along the sides of the rough opening are also lapped over one another to prevent any discontinuities therealong. Finally, since the device does not contact the window assembly, there is no effect any performance or ratings of an installed window.

2. Description of the Prior Art

Devices have been disclosed in the prior art that relate to window framing and sealing elements. These include devices that have been patented and published in patent application publications, and generally relate to retrofit elements, improved window frames and water dam elements placed around the rough opening prior to the window being installed. No devices have thus far been disclosed having the novel elements of providing both a moisture barrier and a clean caulking surface for using against a rough opening, whereby the rough opening is covered prior to the window frame being installed therein. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 6,161,344 to Blanchett discloses a waterproof window flange for use in conjunction with a conventional window frame that prevents water from entering the window, eliminates the need for caulking and eliminates the need for cutting the siding or subsiding during installation. The device comprises a vertical member, a horizontal member and a backward extending member positioned on the distal end of the horizontal member. The device is placed above a window frame to block water intrusion, whereby the horizontal member extends away from the siding, the vertical member is attached to the siding and the backward overhand member overlaps an existing window flange. The Blanchett device, while disclosing an additional member about the window frame, fails to disclose a means of covering the rough opening material, which is generally a plurality of material types that requires caulking thereover. The Blanchett device, rather, proposes a means of preventing water from contacting the interface between the rough opening and the window frame, thereby eliminating the need to caulk, The present invention provides greater water and air resistance, while also providing a uniform substrate to apply sealant material thereto.

U.S. Pat. No. 6,305,130 to Ackerman, Jr. discloses a flashing assembly adapted to be placed between a window frame and a rough opening. The flashing assembly comprises an inner lip that fits within the rough opening and an outer flange that covers a portion of the wall around the rough opening. The inner lip forms a water dam that extends outward from the covered rough opening, where the outer flange is adhered to the peripheral exterior of the rough opening. The water dam prevents water infiltration and the flanges secure to the rough opening and wrap around the window nailing flange. The nailing flange and flashing material are both nailed into the rough opening to secure the assembly and the window. While disclosing an article of window flashing to prevent water penetration, the structure, intent and installation technique of the Ackerman, Jr. device fails to anticipate the present invention.

U.S. Pat. No. 6,725,610 to Murphy discloses a seal construction for a nail-on window or door frame. Among several embodiments, an L-shaped retrofit seal member comprises an L-shaped planar structure having a first and second perpendicular leg for overlying the front face of a wall adjacent to the frame. A first flange extending outwardly from the first leg overlies and attaches to the window frame and a second flange from the second leg for attachment to the frame adjacent to the jamb. The Murphy device fails to provide a means of covering a rough opening interface such that sealing or caulking material may be easily applied thereto, and further does not disclose the structure of the present invention.

The present invention provides a sealing element that prevents air and moisture gaps across the thickness of a window rough opening, whereby the element comprises an elongated sheet of material formed into a defined cross section and fastened to the perimeter of the rough opening prior to mounting the window frame therein. The device provides a physical dam and a uniform caulking surface for applying sealant material between the rough opening and the window frame. The device construction and its method of installation during window construction are both substantially divergent from the prior art. It is clear that there is a need in the art for an improvement to existing window rough opening seal devices. In this regard the instant invention substantially fulfills these needs.

### SUMMARY OF THE INVENTION

In view of the foregoing disadvantages inherent in the known types of window sealing elements now present in the prior art, the present invention provides a new window rough opening seal and method of installing a window, wherein the same can be utilized for providing convenience for the user when installing a window frame into a rough opening during a construction project.

It is therefore an object of the present invention to provide a new and improved rough opening seal that has all of the advantages of the prior art and none of the disadvantages.

It is another object of the present invention to provide a rough opening seal element that comprises an elongated, formed structure that functions as a physical dam for moisture and provides a uniform surface upon which to apply caulking.

Another object of the present invention is to provide a rough opening seal that eliminates cold joints and air gaps between a window rough opening and a window frame during construction to improve the thermal efficiency of the indoor space.

Yet another object of the present invention is to provide a rough opening seal that is adapted to cover the cross section of a rough opening and provide a design that is suitable for exterior façade of different styles and types.

Another object of the present invention is to provide a rough opening seal that is formed of a single, elongated sheet of material that is bent into a design the offers a return flange, a nailing flange and an optional exterior façade flange.

Another object of the present invention is to provide a rough opening sealing method that can be easily incorporated into existing steps for installing a window into a rough opening, where the seal device provides functionality for sealing the window and protecting the window frame during the installation of exterior façade after the window in installed.

A final object of the present invention is to provide a rough opening seal device that can become a decorative border around an installed window frame, offering not only functional elements, but esthetic benefits to the building owner.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of a first embodiment of the present invention contemplated for use with stucco façade buildings.

FIG. 2 shows a perspective view of a second embodiment of the present invention contemplated for use with brick façade buildings.

FIG. 3 shows a cross section view of the second embodiment in a working state, installed between a window frame and a window rough opening.

FIG. 4 shows a cross section view of the first embodiment in a working state, installed between a window frame and a window rough opening.

FIG. 5 shows a view of the present invention being installed along a rough opening jamb.

FIG. 6 shows a view of the corner joint of the present invention to seal, whereby cold joints are prevented.

### DETAILED DESCRIPTION OF THE INVENTION

Reference is made herein to the attached drawings. Like reference numerals are used throughout the drawings to depict like or similar elements of the window rough opening seal. For the purposes of presenting a brief and clear description of the present invention, the preferred embodiment will be discussed as used for providing an air and moisture barrier for the rough opening of a window to improve efficiency within the building, the longevity of the joint itself, and the esthetics of the window border. The figures are intended for representative purposes only and should not be considered to be limiting in any respect.

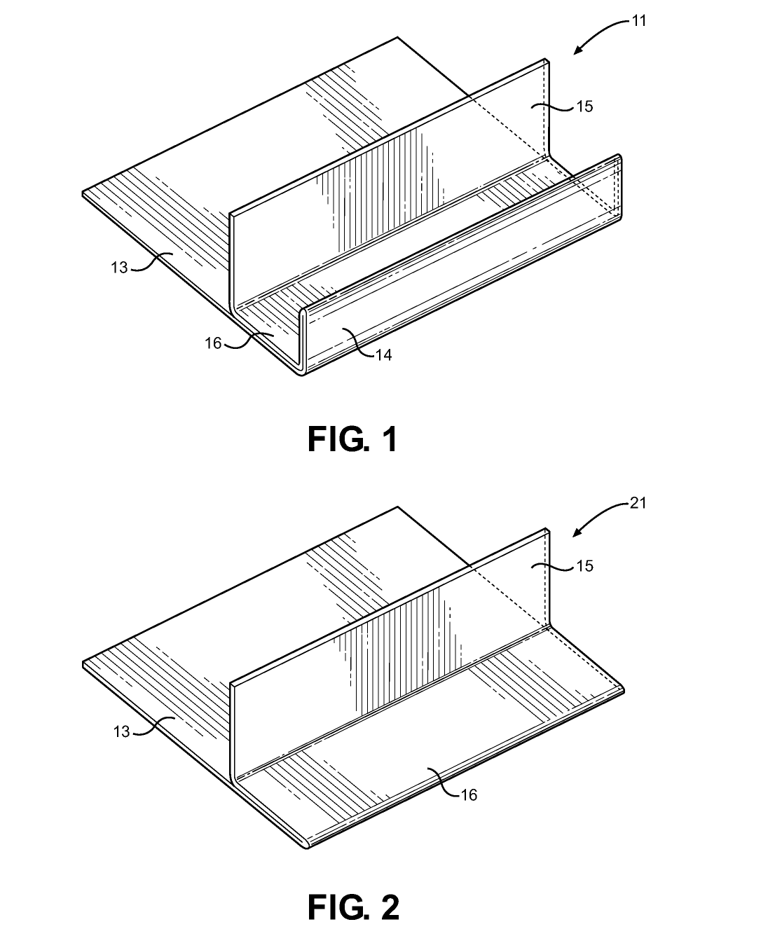

Referring now to FIG. 1, there is shown a perspective view of the first embodiment 11 of the present invention. The device is an article of window flashing the provides a weather barrier across a window rough opening, whereby the flashing is adapted to be installed prior to the window frame being mounted within the window rough opening and also prior to the exterior façade being installed. The device comprises an elongated member of sheet material formed into a defined shape such that when installed, the device acts as a moisture dam, a clean surface to apply caulking between the rough opening and the window frame, and a means to prevent damage to an installed window frame while an exterior façade is being applied to a building. The formed structure comprise a return flange 13 having a first 23 and second 22 end, whereby the return flange forms the body of the device and the structure that covers the cross section of the rough opening. At the second end 22, the material is formed perpendicularly outward from the return flange 13 and then folded onto itself to create an outer flange 14. This outer flange 14 is adapted to extend outward from the rough opening along the exterior of the house, offsetting the window frame from a stucco or EIFS (Exterior insulation and finishing system) façade material, whereby its outer surface provides a decorative feature bridging any gap between the window and the façade, while also creating a termination point for the façade material. Continuing from the outer flange 14, the flashing material is forms against the return flange 13 to establish a moisture dam 16. Finally, the material forms another perpendicular bend that establishes a nailing flange 15 that is bears against a rough opening exterior surface (backup wall) and receives fasteners therethrough to secure the flashing assembly to the backup wall. Overall this embodiment cross section is an “F” shape.

When installed, the device forms an elongated structure about a window rough opening, whereby the moisture dam 16 prevents water from infiltrating the rough opening by sealing any potential gaps. The material is pre-formed of a unitary sheet of material and cut to specific lengths, reducing time spend bending flashing material during installation. The return flange 13 comprises a first and second surface, whereby the formed flanges extend from the first surface, while the second surface provides a smooth sealing surface. The return flange 13 first surface covers the composite structure of the rough opening and bears thereagainst, where generally the rough opening is a sandwich of different material layers that form the thickness of the wall and the structure surrounding the window rough opening. The return flange 13 second surface is a uniform surface which provides a smooth substrate to accept a layer of caulking or sealant material thereon and between the return flange 13 and the window frame within the rough opening.

Turning to the outer flange 14 of the device, this element provides a decorative surround for a window frame that extends outward from the perimeter of the window when using stucco or EIFS façade. It is contemplated that the present flashing material and the window itself be installed after the stucco or EIFS is installed, which is not the normal order or operations. By allowing providing an offset elements (the outer flange), the façade material is covered along the periphery of the window frame and does not require the stucco handlers to carefully aligned the stucco termination around the frame of the window. This reverse schedule prevents exterior façade tradesman from inadvertently damaging the window frame or deforming the flashing material, which can be costly and also compromise the features of the flashing material. The overall flashing assembly is color specific according to the desire of the owner for the color of the window surround, whereby the outer flange 14 is visible from the exterior, accenting each window and covering any gaps in exterior façade material therearound from sight.

Referring now to FIG. 2, there is shown a second embodiment 21 of the present invention, which comprises a unitary, formed material having a return flange 13, a moisture dam 16, and a nailing flange 15. This embodiment is contemplated for use with brick exterior façade, which is much more controlled than stucco installation. The perimeter of the brick around the window frame can be carefully controlled, eliminating the need to provide an outer flange extension that covers any uneven façade gaps about the installed window. Stucco façade requires workers to spread the stucco material against the exterior of the house, which requires working the stucco material to a uniform termination. Bricks, by contrast, are much easier to align against the perimeter of the window. With brick exterior, the outer flange element is not necessary and is omitted. This second embodiment of the flashing element 21 is installed in the same manner as the first embodiment, whereby fasteners are secured through the nailing flange 15 such that the return flange 13 covers the cross section of the rough opening and the elongated sections of flashing span completely around the periphery of the rough opening prior to window installation.

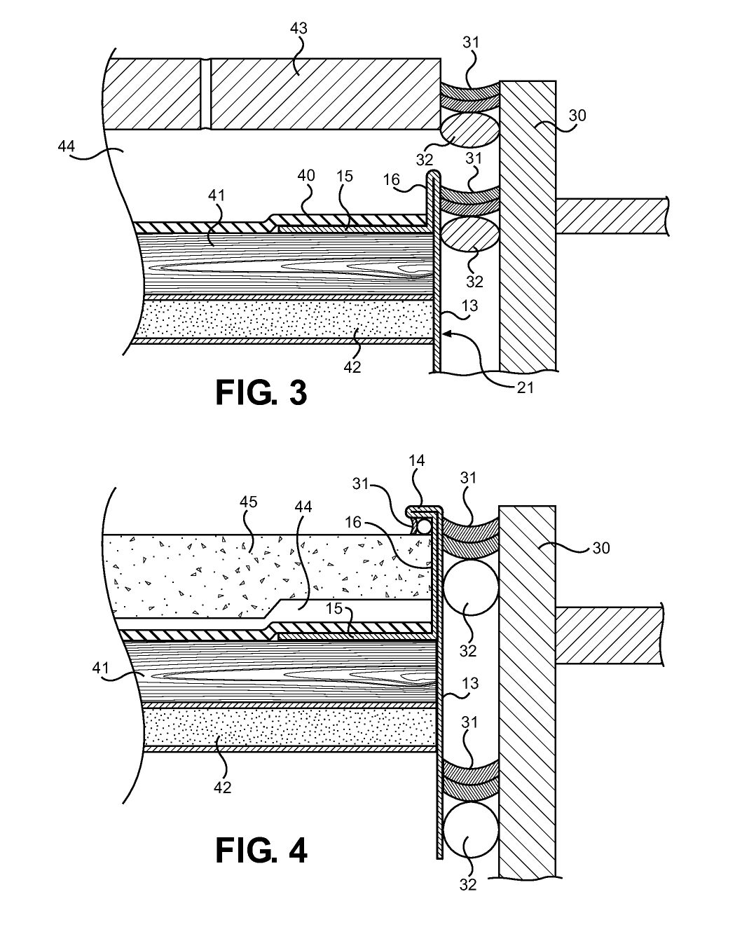

Referring now to FIGS. 3 and 4, there are shown cross section views of the embodiments 11, 21 of the present invention in a working state, installed between a window rough opening and a window frame 30. The perimeter of a rough opening comprises a sandwich of several layers that forms the backup wall upon which the flashing element is secured to. This backup wall generally comprises a layer of wood 42 around the perimeter of the rough opening and gypsum sheathing material 41 supported by wall studs therebehind. The studs form the structure of the wall as is well understood in the art. The flashing assembly secures against the wood surround 41 and covers the cross section of the rough opening for the purposes of preventing air and water infiltration, while also providing a smooth surface to place sealant material between the rough opening and the window frame 30.

The return flange 13 of the flashing assembly covers the rough opening cross section, while the nailing flange 15 bears against the backup wall and is fastened thereto. Once installed, the nailing flange 15 is covered by a bituminous or asphalt membrane layer 40 to further seal the nailing flange 15 against the backup wall. The flashing extends outward from the backup wall to form a water dam 16, while the first embodiment 11 comprises an additional outer flange that secures about the outer, stucco façade 45 material. The second embodiment 21 terminates at a 180 degree bend in the material at the distal end of the moisture dam 16 without providing an additional outer flange. This second embodiment 21 is adapted for brick façade 43. Between the façade and the backup wall is an air gap 44 that provides additional thermal resistance, which can further be utilized to place insulation material if desired by the builder.

Between the window frame 30 and the return flange 13 is sealant material 31. To set the sealant material, backer rods 32 are generally utilized to support the sealant material, whereby the sealant material is forced against the backer rod 32 when “striking the seal,” thereby controlling its thickness and compressing it into the cracks of the gap to ensure an adequate air barrier. The exact procedure of sealing the window frame and its architectural plans may be adapted for a given application; however the use of a smooth return flange 13 provides an even and uniform support surface during the window sealing process. For use with stucco or EIFS façade 45, the outer flange 14 is also sealed 31. Therefore, both installations prevent water and air from entering the air gap 44 behind the façade or entering the gap between the window frame 30 and the flashing return flange 13.

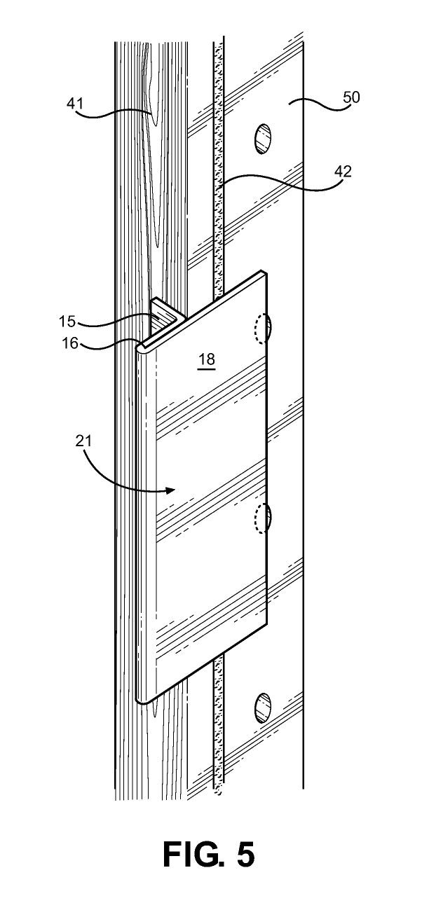

Referring now to FIG. 5, there is shown a perspective view of the present invention 21 in an installed state against a window rough opening jamb. The rough opening sandwich of material is shown, whereby the wood perimeter 41 provides a backup wall, connecting to a layer of sheathing material 24 that is supported by a wall stud 50 therebehind. The return flange second surface 18 is shown, which faces inward within the rough opening interior to support sealant material between the return flange and the window frame. Fasteners are placed through the nailing flange 15 and into the wood 41, while the upstanding moisture dam 16 prevents water from infiltrating the rough opening/window frame interface. During installation, lengths of the flashing are cut to match the dimensions of the window rough opening. Adjacent sections are installed using a lap joint, whereby the flashing is cut such that the ends of the adjoining lengths overlap and are then fastened together. This prevents any gaps in the flashing material, or “cold joints,” from otherwise compromising the effectiveness of the flashing seal.

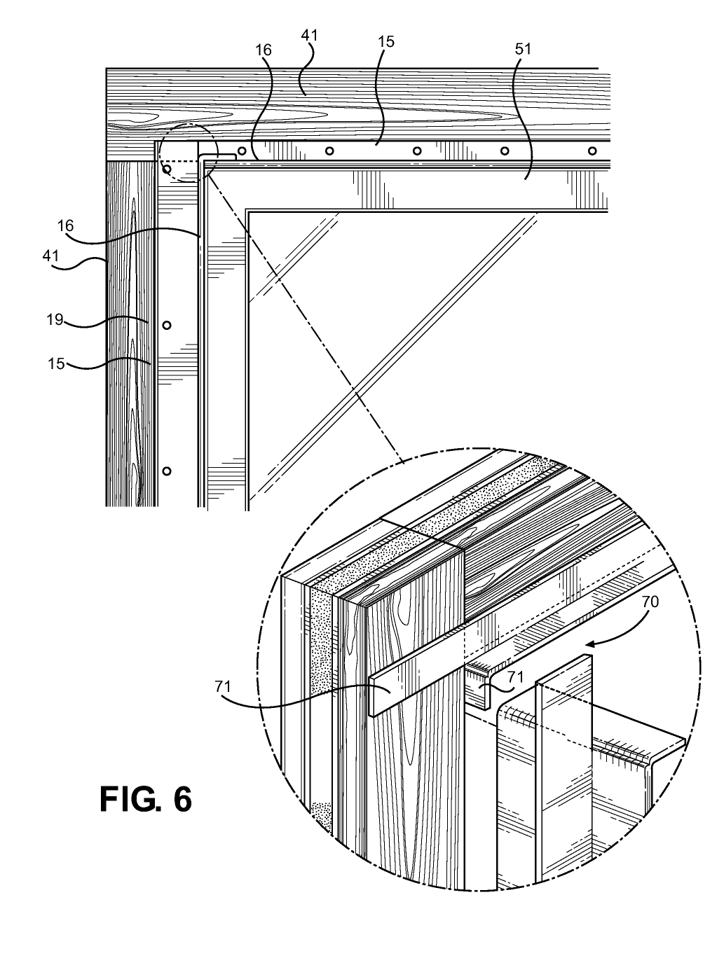

Referring now to FIG. 6, there is shown a view of the joint formed by the perpendicular connection of two adjoining flashing elements in the corner of the window rough opening. To prevent cold joints at the corners 70 and between adjoining segments of the flashing, the flanges are trimmed and overlapped with one another. The flanges are bent across the corner to create overlapping segments 71, while the fasteners in the nailing flange 15 secure the flashing elements against the backup wall wood 41. Once installed, the window can be placed within the opening and the window frame aligns with the moisture dam 16 of the flange to prevent outward protrusions. The window panes 15 and frame themselves are further prevented from damage during the construction process as the siding or façade can be installed prior to the windows.

Along with the structure of the present invention, an associated method of flashing and sealing a window is contemplated. The proposed method allows the builder or contractor to have the freedom of installing the façade of the building prior to window installation, which ensures the finished windows are not damaged in the process of installing the façade. This is generally not the standard schedule of construction; however this flexibility ensures no damage occurs and therefore increased costs are avoided from negligence or carelessness of contractors or tradesman installing façade around an installed window. The steps of the method include gathering and trimming lengths of the correct embodiment of the flashing material to span the perimeter of a window rough opening, before or after the exterior façade is applied. The flashing is nailed into the backup wall whereby the flashing return flange covers the rough opening cross section and the moisture dam extends outward from the backup wall along exterior of the building. Adjoining lengths of flashing along the perimeter and at the corner joints, the flashing is cut to overlap and secured together with fasteners in a lap joint to prevent cold joints. The window frame is then mounted within the rough opening, and backer rods are placed between the window frame and the flashing return flange. Sealant material is then installed over the backer rods to create a water and air tight seal around the window frame. A further backer rod and seal are provided between the façade and the outer flange if so present in the flashing material. Therefore, the windows can be flashed and installed before or after installation of the building exterior façade. Further the color of the window surround can be chosen by selecting an appealing flashing color prior to installation if the first embodiment of the flashing is installed.

The present invention provides a decorative window perimeter, water and air barrier, an improved sealing means, and a flashing assembly that provides builders with flexibility with regard to installation procedures. The material is preferably a metallic structure such as sheet metal; however it is not desired to limit the present invention to one material. Rather it is desired to disclose a novel construction of window flashing that once installed prevents water from entering between a rough opening and a window frame, and further provides flexibility for builders during installation. The present invention not only creates a “dam” around the rough opening, but also provides an excellent surface to seal the window frame to the rough opening. When the invention is installed in the normal construction sequence, it allows the window to be installed after the façade is in place. This schedule prevents damage to the window frame or glass by other tradesman (masonry or stucco contractors). Another benefit is the invention is manufactured in standard lengths and can be field cut to fit any openings. Once installed, the device provides an inexpensive means to improve the thermal efficiency of the window by prevents air infiltration, while also preserving the joint by prevent moisture penetration. Finally, since it does not contact the window assembly, there is no effect any performance or ratings of the installed window.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A window rough opening seal device, comprising:
an elongated sheet of material formed into a defined shape for flashing a window rough opening;
said sheet of material having a return flange with a first and second end and a first and second side surface;
said return flange first surface adapted to face inward within a window rough opening and said second surface adapted to face said rough opening perimeter;
said return flange second end forming a radius that transitions into an outer flange perpendicular with said return flange second surface, said outer flange having a distal end;
said sheet of material folding over itself at said outer flange distal end and forming against said return flange radius;
said sheet of material extending from said return flange radius against said return flange second surface to form a moisture dam;
said sheet of material forming a nailing flange from said moisture dam perpendicular with said return flange second surface.

2) The device of claim 1, wherein said return flange first surface is a flat, uniform surface upon which sealant material may be applied.

3) The device of claim 1, wherein said material flanges are easily trimmed to length to fit a window rough opening and for overlapping adjacent segments.

4) The device of claim 1, wherein said material further comprises a color such that said outer flange.

5) A window rough opening seal device, comprising:
an elongated sheet of material formed into a defined shape for flashing a window rough opening;
said sheet of material having a return flange with a first and second end and a first and second side surface;
said return flange first surface adapted to face inward within a window rough opening and said second surface adapted to face said rough opening perimeter;
said sheet of material folding over itself at said return flange second end and extending from said return flange second end against said return flange second surface to form a moisture dam;
said sheet of material forming a nailing flange from said moisture dam perpendicular with said return flange second surface.

6) The device of claim 5, wherein said return flange first surface is a flat, uniform surface upon which sealant material may be applied.

7) The device of claim 5, wherein said material flanges are easily trimmed to length to fit a window rough opening and for overlapping adjacent segments.

8) The device of claim 5, wherein said material further comprises a color such that said outer flange.

9) A method of sealing a window rough opening, comprising the steps of:
trimming lengths of a formed flashing material having a return flange having a parallel moisture dam and a perpendicular nailing flange formed of a single sheet of material;
placing said return flange against said rough opening cross section and securing said nailing flange against the exterior perimeter of said rough opening via fasteners;
overlapping said trimmed lengths of material in a lap joint configuration to prevent gaps between segments;
mounting a window frame within said rough opening;
placing sealant material between said flashing return flange and said window frame.

10) The method of claim 9, further comprising the steps of:
first placing façade around the rough opening prior to securing said nailing flange thereto.

11) The method of claim 9, wherein said flashing material lengths further comprise:
an outer flange perpendicular to said return flange, wherein said outer flange is adapted to shroud façade material.

12) The method of claim 11, further comprising the steps of:
placing sealant material between said outer flange and said façade material.

13) The method of claim 9, further comprising the steps of:
placing a membrane seal over said secured nailing flange about said window rough opening perimeter.

14) The method of claim 9, wherein said placement of sealant material further comprising the steps of:
placing backer rods between said return flange and said window frame;
forcing sealant material against said backer rods to seal any gap between said return flange and said window frame.

15) The method of claim 9, further comprising the steps of:
choosing a particular flashing material color that is suitable to said user prior to trimming said material lengths.
